(19) United States
(12) Patent Application Publication
(10) Pub. No.: US 2007/0279774 A1
(43) Pub. Date: Dec. 6, 2007

(54) Projecting device

(75) Inventor: Ching-Shuai Huang, Changhua County (TW)

Correspondence Address: RABIN & Berdo, PC, 1101 14TH STREET, NW, SUITE 500, WASHINGTON, DC, 20005, US

(73) Assignee: BenQ Corporation, Taoyuan Shien (TW)

(21) Appl. No.: 11/802,346

(22) Filed: May 22, 2007

(30) Foreign Application Priority Data
May 30, 2006 (TW) 95119264

(51) Int. Cl. G02B 5/04

(52) U.S. Cl. 359/831

(57) ABSTRACT

A projecting device includes a light source, a lens-mirror, a panel and a projection lens. The light source is for generating a light. The lens-mirror made of transparent material has a first convex surface and a reflective surface both of which are positioned relatively to the light. The lens-mirror refracts and reflects the light to the panel. The panel reflects the light from the lens-mirror to the projection lens. The projection lens receives the light from the panel and projects the light onto the screen to form an image.

This application claims the benefit of Taiwan application Serial No. 095119264, filed May 30, 2006, the subject matter of which is incorporated herein by reference.

### BACKGROUND OF THE INVENTION

1. Field of the Invention

The invention relates in general to a projecting device, and more particularly to a projecting device with better light gathering power.

2. Description of the Related Art

FIG. 1 illustrates a conventional projector. Please referring to FIG. 1, the conventional projector 10 includes an illumination system, a digital micro-mirror device (DMD) chip 7 and a projection lens 8. The illumination system includes a lamp 1, a lamp cap 1a, a color wheel 2, a light integrator 3, a condenser assembly 4, a fold mirror 5 and a concave mirror 6.

First, light emitted by the lamp 1 is focused by the lamp cap 1a and passes through the color wheel 2 to generate the light with three primary colors. Then, the colored light is uniformized by the light integrator 3 and then directed onto the surface of the DMD chip 7 through the condenser assembly 4, the fold mirror 5 and the concave mirror 6. According to the rotation state of each reflective mirror on the DMD chip 7, the light directed onto the DMD is alternatively reflected away from the projection lens 8 or into the projection lens 8. As a result, the DMD chip 7 converts electric signals into an optical images. Afterwards, the projection lens 8 projects the images onto a screen.

Through the condenser assembly 4, the fold mirror 5 and the concave mirror 6, the light from the light integrator 3 may be transformed into a light beam focuses on the entire DMD chip. If the light beam is not converged to a certain level, the field that the light beam emitted onto will be larger than the DMD chip. As a result, part of the light beam is reflected by other components and scattered in the projector. Light leakage occurs, and the contrast of the image is deteriorated greatly.

Generally, the light path of the projector or the curvature radius of the concave mirror is increased in order to solve the above problem. However, the concave mirror is manufactured by grinding a reflective mirror, so that it is hard to manufacture one with a large curvature radius. Furthermore, when the light path is increased, the volume of the projector is increased as well. The demand for compact projectors is hard to be satisfied, and the competitiveness of the projector is lowered.

### SUMMARY OF THE INVENTION

The invention is directed to a projecting device, in which a lens-mirror in the illumination system has properties of both the convex lens and the concave lens for a gain in light gathering power. Therefore, light is more focused, and the light gathering power is enhanced within the limited space. Also, the aberration is reduced.

According to the present invention, a projecting device including a light source, a lens-mirror, a panel and a projection lens is provided. The light source is for generating a light. The lens-mirror has a first convex surface and a reflective surface both of which are relative to the light for refracting and reflecting the light. The panel reflects the light from the lens-mirror to the projection lens, and the projection lens projects the light onto a screen to form an image.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) illustrates a conventional projector;

FIG. 2 illustrates a projecting device according to a first embodiment of the present invention;

FIG. 3 is an enlarged view of a lens-mirror and a panel of the projecting device in FIG. 2;

FIG. 4 is an enlarge view of the lens-mirror and the panel of the projecting device according to a second embodiment of the present invention; and

FIG. 5 illustrates the projecting device according to a third embodiment of the present invention.

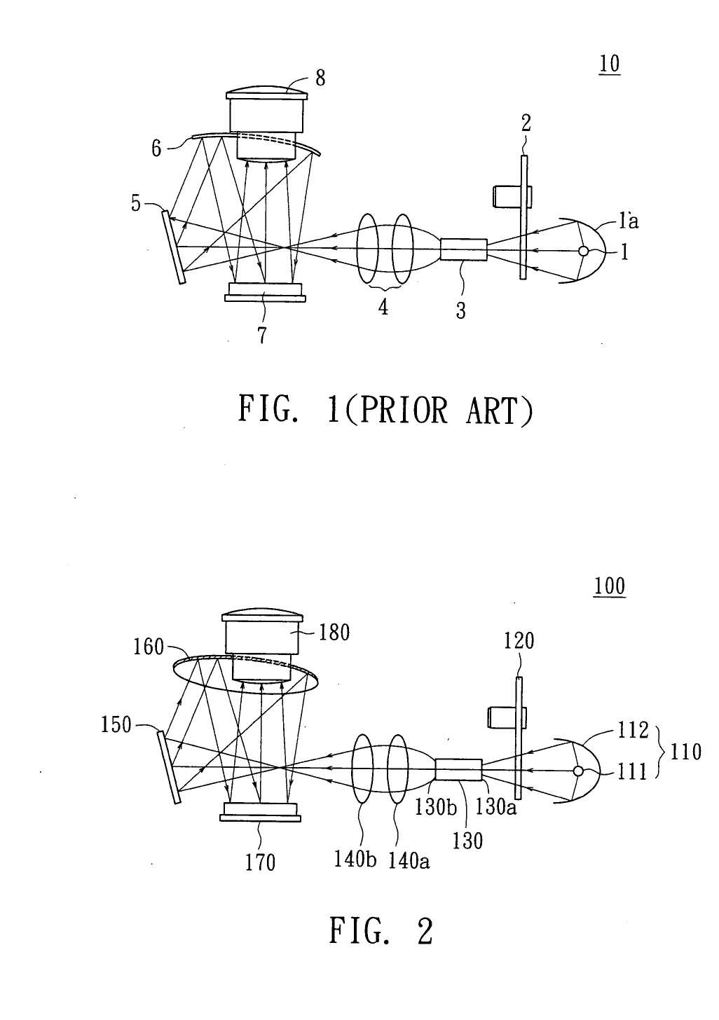

### DETAILED DESCRIPTION OF THE INVENTION

Some embodiments are described as follow to illustrate the present invention. However, the present invention is not limited thereto. One ordinary skill in the art of the invention understands that various modifications can be made to adjust the light path without departing from the spirit of the invention.

In the present invention, a lens-mirror is used for replacing the conventional concave mirror. The lens-mirror has the properties of both the convex lens and concave lens. Therefore, light is more focused in the projecting devices according to the embodiments of the present invention.

### First Embodiment

Please referring to FIG. 2, a projecting device according to a first embodiment of the present invention. For example, the projecting device is a projector or a rear projection television. The projecting device 100 of the present embodiment includes a light source 110 (such as a lamp 111 and a lamp cap 112), a color wheel 120, a light integrator 130, condenser lenses 140a and 140b, a fold mirror 150, a lens-mirror 160, a panel 170 and a projection lens 180. For example, the panel 170 is a digital micro-mirror device (DMD) chip or a liquid crystal display panel (LCD) panel.

When the projecting device 100 functions normally, the lamp 111 which electronic ballast provides with operation power generates light. The lamp cap 112 is disposed around the lamp 111 and encloses the lamp 111, for gathering the light generated by the lamp 111. The lamp cap 112 is preferably an elliptic lamp cap or a conventional parabolic lamp cap with a convex lens. The light generated by the lamp 111 passes through the color wheel 120. Generally, the color wheel 120 is a circular plate with three primary colors including red, green and blue, and driven by a motor to rotate. After the light passes through the color wheel 120, light beams with different primary colors are generated in sequence.

The light integrator 130 is disposed on a side of the lamp cap 112 for uniformizing the light emitted to the light integrator 130. The light integrator 130 has an inlet end 130a and an outlet end 130b. The inlet end 130a of the light integrator 130 is corresponding to a focus point, so that the light gathered by the lamp cap 120 enters the light integrator 130.

The condenser lenses 140a and 140b are disposed relatively to the light integrator 130. For example, the condenser lenses 140a and 140b are disposed on a side of the light integrator 130 for condensing the uniformized and colored light from the light integrator 130 and making the light pass through.

The fold mirror 150 is disposed relatively to the light source 110 for reflecting the light from the condenser lenses 140a and 140b onto the lens-mirror 160.

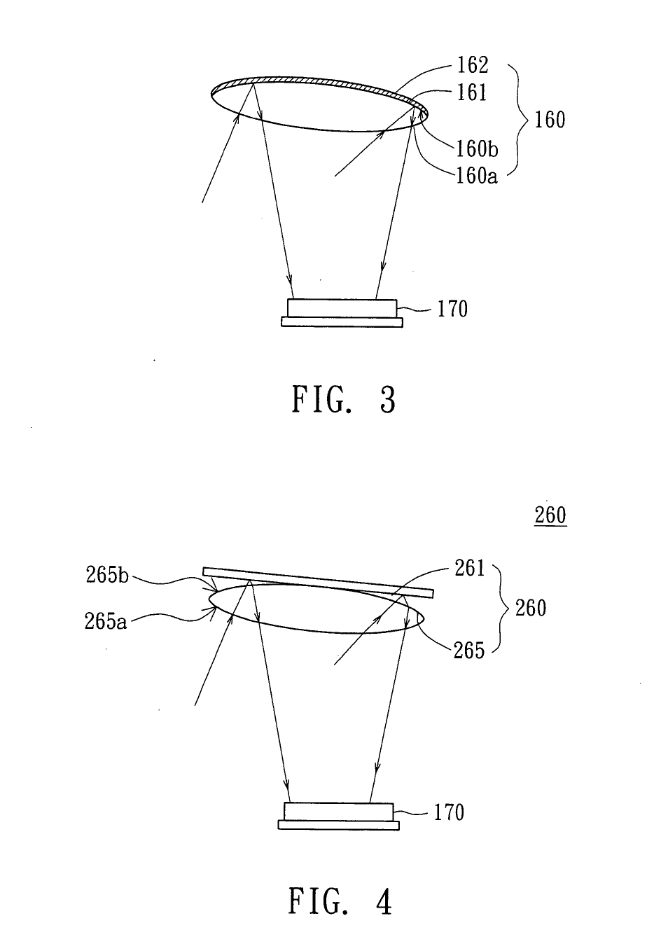

FIG. 3 is an enlarged view of the lens-mirror and the panel of the projecting device in FIG. 2. The lens-mirror 160 is a convex lens with a first convex surface 160a and a second convex surface 161. The second convex surface 161 is coated with a reflective material 162 to form a reflective surface 160b. The first convex surface 160a is positioned relatively to the light. After passing through the first convex surface 160a, the light is refracted (first refraction) to the reflective surface 160b in the convex lens. Afterwards, the light is reflected by the reflective surface 160b back to the first convex surface 160a. Then, the light is refracted (second refraction) out from the convex lens. Accordingly, a, light beam is projected onto the panel 170. What is worth mentioning is that the light is refracted twice and reflected once in the lens-mirror in the present embodiment while the light is only reflected once in the prior art.

Therefore, light is more focused in the present embodiment than that in the prior art. Furthermore, the lens-mirror 160 has properties of both the convex lens and the concave lens. Light is focused better without increasing the light path.

The light beam gathered by the lens-mirror 160 covers the entire panel 170. The panel 170, for example, is a DMD chip which many ultra-small-size mirrors (14 μm) are hinged on. The panel 170 reflects the light from the lens-mirror 160 to the projection lens 180, and the projection lens 180 projects the light onto a screen to form an image.

### Second Embodiment

The projecting device of a second embodiment and that of the first embodiment are different in the structure of the lens-mirror. The rest of the components using the same reference numbers are the same and not described repeatedly.

FIG. 4 is an enlarged view of the lens-mirror and the panel of the projecting device according to the second embodiment of the present invention. The lens-mirror 260 of the present embodiment includes a convex lens 265 and a reflective mirror 261. The convex lens 265 has a first convex surface 265a and a second convex surface 265b. The first convex surface 265a is positioned relatively to the light reflecting by the fold mirror 150. The reflective mirror 261 is disposed relatively to the second convex surface 265b. After passing through the first convex surface 265a (first refraction) and the second convex surface 265b (second refraction), the light is reflected (first reflection) by the reflective mirror 261 onto the second convex surface 265b. Then, the light passes through the second convex surface 265b (third refraction) and the first convex surface 265a (fourth refraction) to be focused onto the panel 170.

### Third Embodiment

The projecting device of a third embodiment and that of the first embodiment are different in the location of the lens-mirror. The location of the lens-mirror and that of the fold mirror are exchanged. The rest of the components using the same reference numbers are the same and not described repeatedly.

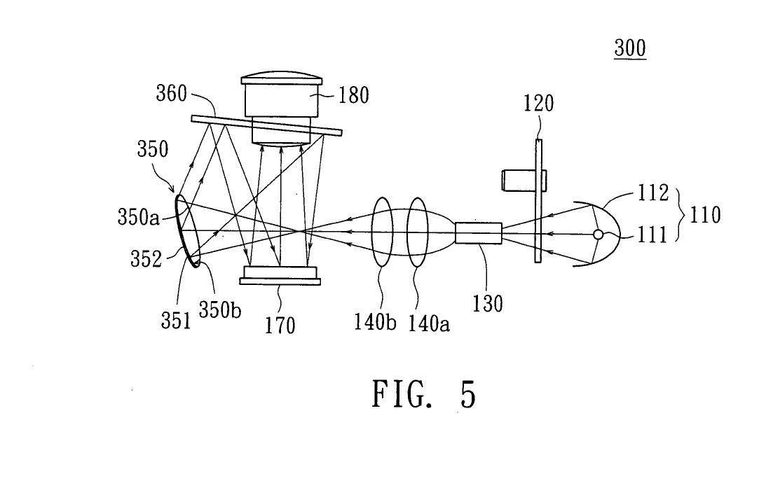

Please referring to FIG. 5 which illustrates the projecting device according to the third embodiment of the present invention. In the projecting device 300, the lens-mirror 350 is disposed relatively to the light source 110 for reflecting the light from the condenser lenses 140a and 140b to the fold mirror 360. The lens-mirror 350 is a convex lens with a first convex surface 350a and a second convex surface 351. The second convex surface 351 is coated with a reflective material 352 to form a reflective surface 350b. The first convex surface 350a is positioned relatively to the light. After passing through the first convex surface 350a, the light is refracted (first refraction) in the convex lens onto the reflective surface 350b. Then, the light is reflected back to the first convex surface 350a by the reflective surface 350b. Afterwards, the light is refracted (second refraction) out from the convex lens 350. Accordingly, the light beam is projected onto the fold mirror 360, and the fold mirror 360 reflects the light beam onto the panel 170.

Furthermore, the lens-mirror of the present embodiment can include a reflective mirror and a convex lens to obtain the same effect.

In the projecting devices according to the above embodiments of the present invention, the lens-mirror has the properties of both the convex lens and concave lens, so the light is focused better. As a result, the light beam is more condensed when projecting onto the panel. The light gathering power is enhanced greatly, and the aberration is reduced. Also, the luminance efficiency is increase. Therefore, the light is prevented from projecting onto other components and scattering in the projecting device. The light leakage is reduced, and the contrast of the image is increased. Moreover, the lens-mirror has better light gathering power, so that some components, such as condenser lenses, could be omitted for simplifying the structure and shortening the light path. The device is more compact and meets the market demand. On the other hand, it is easy to fabricate the lens-mirror with the convex lens and reflective mirror than the conventional concave mirror. Also, the curvature radius and the radian of the lens-mirror can be reduced since the lens-mirror has better light gathering power. The lens-mirror of the present invention is easier to fabricate.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A projecting device comprising:
a light source for generating a light;
a lens-mirror having a first convex surface and a reflective surface, the first convex surface and the reflective surface positioned relatively to the light for refracting and reflecting the light;
a panel reflecting the light from the lens-mirror; and
a projection lens receiving the light from the panel and projecting the light onto a screen to form an image.

2. The device according to claim 1, wherein the lens-mirror comprises:
a convex lens with the first convex surface and a second convex surface, the second convex surface coated with a reflective material to form the reflective surface, the first convex surface positioned relatively to the light.

3. The device according to claim 1, wherein the lens-mirror further comprises:
a convex lens with the first convex surface and a second convex surface, the first convex surface positioned relatively to the light source; and
a reflective mirror with the reflective surface disposed relatively to the second convex surface.

4. The device according to claim 1 further comprising:
a fold mirror disposed relatively to the light source for reflecting the light generated by the light source onto the lens-mirror.

5. The device according to claim 1 further comprising:
a fold mirror receiving the light from the lens-mirror and reflecting the light onto the panel.

6. The device according to claim 1, wherein the light source comprises:
a lamp for generating the light; and
a lamp cap disposed around the lamp and enclosing the lamp for gathering the light generated by the lamp to a focus point.

7. The device according to claim 6 further comprising:
a color wheel disposed beside the light source for generating the light with three primary colors after passing through the color wheel; and
a light integrator disposed beside the color wheel with one end of the light integrator being corresponding to the focus point, for uniformizing the light with three primary colors.

8. The device according to claim 7 further comprising:
a condenser assembly disposed relatively to the light integrator for condensing the uniformized light emitted from the light integrator and projecting the light onto the lens-mirror.

9. The device according to claim 1, wherein the panel is a digital micro-mirror device (DMD) chip.

10. The device according to claim 1, wherein the panel is a liquid crystal display panel (LCD panel).

11. The device according to claim 1 being a projector.

12. The device according to claim 1 being a rear projection television.
